(19) United States
(12) Patent Application Publication
(10) Pub. No.: US 2008/0181107 A1
(43) Pub. Date: Jul. 31, 2008

(54) Methods and Apparatus to Map and Transfer Data and Properties Between Content-Addressed Objects and Data Files

(76) Inventors: Jay R. Moorthi, Sunnyvale, CA (US); Jeffrey D. Merrick, Sunnyvale, CA (US)

Correspondence Address: NETWORK APPLIANCE/BLAKELY, 1279 OAKMEAD PARKWAY, SUNNYVALE, CA, 94085-4040, US

(21) Appl. No.: 11/669,121

(22) Filed: Jan. 30, 2007

(51) Int. Cl. G08C 15/00

(52) U.S. Cl. 370/231

(57) ABSTRACT

Methods of iterating through a set of data objects on a source server, copying them to a destination server, and preparing a mapping database correlating source and destination data object identifiers are described and claimed. The mapping database also includes data retention policy information and policy discrepancy information. Systems using similar methods, and software to perform similar methods, are also described and claimed.

### FIELD

The invention relates to mapping data objects during data migration. In particular, the invention relates to migrating data objects between filesystem-structured storage and content-addressed storage.

### BACKGROUND

Many businesses and organizations generate large volumes of data in the course of their operations. This data may have intrinsic value (i.e. it may be sold or rented directly) or it may simply support other revenue-generating functions. In either case, reliable data storage and timely data retrieval capabilities are important. In addition, some businesses are subject to formalized data maintenance requirements. For example, financial and medical service providers are obligated by law to keep certain types of records for many years, and furthermore to keep ancillary information that can establish the provenance of those records. Record retention requirements may dictate that data be stored in an unmodifiable (read-only) and undeletable form, that any changes be detectable, or that significant events affecting a data record be identifiable through a chain-of-custody manifest. Various data storage systems that comply with statutory requirements and fulfill related business needs have been developed and deployed.

One approach to implementing a legally adequate record management system is to extend the functionality of a traditional data storage system such as a network-accessible fileserver to include verifiable read-only storage and chain-of-custody logging. Verifiable read-only storage means that storage safeguards are in place to prevent data from being changed or deleted after it is stored, and/or to permit any changes to be identified so that the original data can be recovered, and the time, date and circumstances of any change are readily apparent. Chain-of-custody logging permits a forensic analyst to reconstruct the history of a record, so that it can be determined how the record came to have its present contents and location, and what other systems and procedures might have affected the record over its lifespan. Such a storage server may also provide ordinary data storage functions.

Another approach to implementing a legally adequate record management system is to provide “content-addressable storage” (“CAS”), where a stored data record becomes associated with a key that is based on the contents of the record. If the record is modified, it can no longer be accessed by the key. A CAS server presents an interface that is quite different from that of a traditional fileserver, so interactions with a CAS server typically occur according to a proprietary protocol instead of a standard protocol such as Network File System (“NFS”) or Common Internet File System (“CIFS”).

It sometimes happens that data records subject to retention policy requirements must be moved from one type of system to another type of system. For example, a business may wish to move its data from a CAS server to a filename-addressable storage (“FAS”) server, or vice versa. When this occurs, the normal difficulties of moving large amounts of data are complicated by the need to maintain chain-of-custody records describing the move and by the fact that an application that produces or uses the data records must remain in service throughout the transfer process. Also, legal restrictions governing the use of certain proprietary protocols may prevent some transfer methods. In addition, it is possible that identical record retention policy semantics do not exist on the destination system—for example, the source system may provide read-only storage, with no possibility to change or delete records, while the destination system may permit modifications but track any changes so that they can be audited or undone. Retention policy semantic differences should also be identified and recorded to facilitate forensic analysis.

Data migration methods that address these (and other) difficulties may be of value in environments like those described above.

### SUMMARY

Data can be transferred by iterating through a set of data objects stored on a source server and copying a source data object to a destination server. A record containing identifiers of the data object at the source and destination servers, and record retention policy information (including any retention policy discrepancies) is made in a mapping database.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows an environment where an embodiment of the invention operates.

FIG. 2 presents a portion of the environment in greater detail.

FIG. 3 is a flow chart outlining a method according to an embodiment of the invention.

FIG. 4 is a flow chart outlining another aspect of an embodiment of the invention.

FIG. 5 shows an alternate logical arrangement of systems in an environment where an embodiment operates.

### DETAILED DESCRIPTION

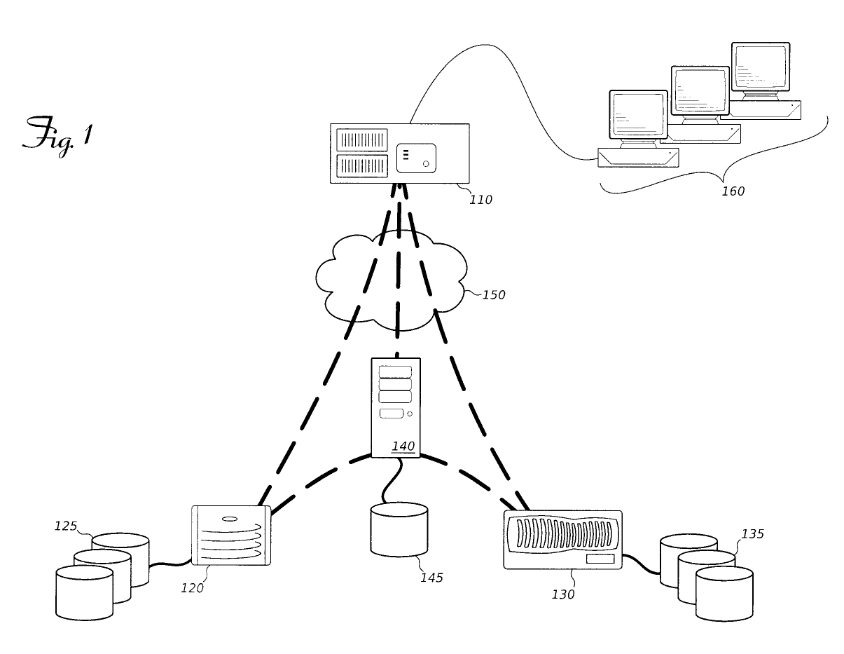

FIG. 1 shows an environment where an embodiment of the invention operates. At a high level, the environment can be thought of as a computerized system to collect and store important information such as financial data or medical records. The components of the system cooperate to ensure that the information is stored in accordance with applicable laws and regulations, so that errors and intentional data tampering can be traced back to their source and appropriate corrective action taken.

An application server 110 is in communication with a content-addressable storage (“CAS”) server 120 and a filename-addressable storage (“FAS”) server 130. CAS server 120 stores data on a group of mass storage devices 125, which may be operated as a Redundant Array of Independent Disks (“RAID array”). Similarly, FAS server 130 stores data on a group of mass storage devices 135, which may also be operated as a RAID array. The low-level details of data storage (e.g. RAID level, amount of storage available, etc.) are not described here, because they would be apparent to those of ordinary skill in the relevant arts. Logical communication channels between application server 110 and the CAS and FAS servers 120, 130 are indicated in this figure by heavy dashed lines. Communication may occur over public, private or virtual private networks such as local area networks (“LANs”), wide-area networks (“WANs”) or other communication facilities. Some data may flow over a distributed public data network such as the Internet 150. Client computers 160 communicate with application server 110 and issue transactions to cause application server 110 to store new records on CAS server 120 and/or FAS server 130, or to retrieve previously-created records from CAS server 120 and/or FAS server 130. Director computer 140 is in communication with application server 110, CAS server 120 and FAS server 130, and maintains a mapping database 145 according to methods discussed below. Although director computer 140 is shown as a distinct physical entity in this figure, embodiments of the invention may co-locate its functionality with one of the other servers, such as application server 110, CAS server 120 or FAS server 130. In addition, mapping database 145 may be stored or maintained by a separate database server (not shown), with which director computer 140 interacts.

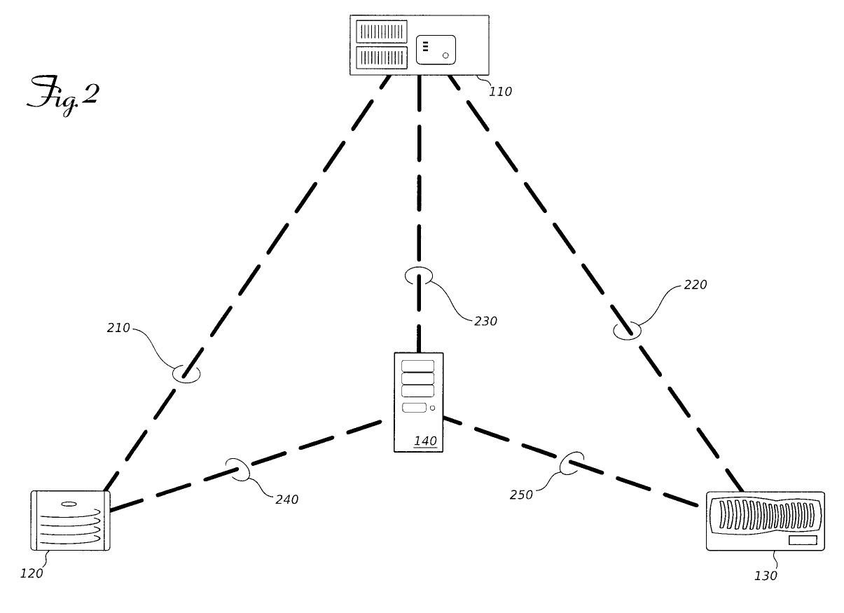

FIG. 2 identifies more details of the interactions between application server 110, CAS server 120, FAS server 130 and director computer 140. As noted above, the functionality of director computer 140 may be co-located with one of the other servers. Although it is convenient to describe director 140 as a separate and independent computer, it is appreciated that embodiments of the invention depend only on the logical operations described being performed somewhere in the computing environment, and not necessarily at a single identifiable “director” computer.

Data processing systems in communication with each other interact according to various protocols. Protocols are designed to provide a constellation of attributes such as simplicity, descriptive precision, security, data throughput, and so on. However, once a protocol is selected for use, all communicating entities must produce and accept messages that conform to the protocol. Some entities may implement multiple protocols.

The five communication channels identified as 210, 220, 230, 240 and 250 in FIG. 2 may all carry messages that conform to different protocols. However, in a common environment, it is likely that communications between application server 110 or director 140 and CAS server 120 (i.e. communications where CAS server 120 is an endpoint) will conform to a first protocol; and communications between application server 110 or director 140 and FAS server 130 (FAS server 130 is an endpoint) will conform to a second protocol. Communications between application server 110 and director 140, over channel 230, may conform to either the first or second protocol, or to a third, different protocol.

As mentioned earlier, protocols differ in various characteristics (as well as in the composition of individual messages that conform to the protocol). With respect to embodiments of the present invention, an important characteristic is whether the protocol is public or proprietary. A public protocol is one that is described in freely-available documentation and that can be implemented and used without restriction. (It is important to distinguish a public protocol from a name of the protocol, which may be trademarked or otherwise restricted from general use.) Network File System (“NFS”) is a public protocol that is commonly used between data processing systems when one system provides filename-addressable data storage services to another system.

A proprietary protocol, in contrast, is one that is not described in freely-available documentation or that cannot be implemented and used without restriction. Proprietary protocols may be protected by patent rights, licensing agreements, or simple obscurity. Proprietary protocols are often developed in situations where interoperability is not an issue, such as when the same company controls both the client and server implementations. Examples of this in the streaming media world are Microsoft's Multimedia Messaging Service (“MMS”) and Real Media's RDP protocol. Mapping and data exchange as contemplated by embodiments of the invention become important when another program or product seeks to interoperate with the proprietary system according to a protocol that is subject to legal or technical restrictions.

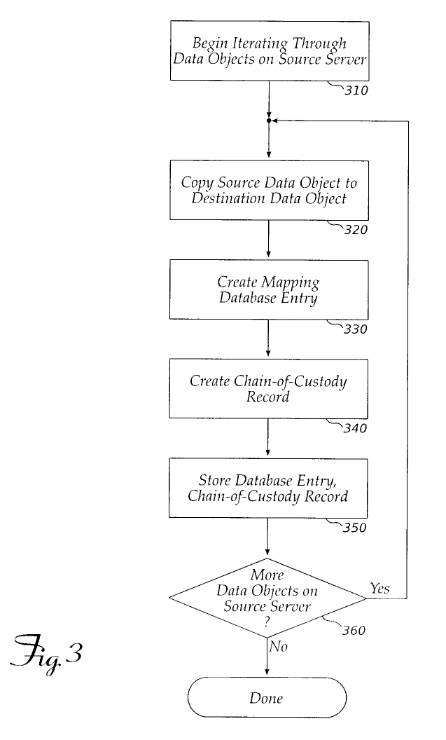

An embodiment of the invention can operate generally as outlined in the flow chart of FIG. 3 to transfer a plurality of data records from one system to another. First, the embodiment begins iterating through the data objects to be moved from the source server (310). If the source server provides a name-based hierarchical filesystem, the iteration may begin at a directory and proceed alphabetically or in some other order. If the source server provides content-addressable storage, data objects may be located through operations conceptually similar to “first” and “next,” though it may not be possible to determine any particular temporal or hierarchical relationship between the objects.

For each data object encountered during the iteration, the contents of the source data object are copied to a newly-created destination data object at the destination server (320). The destination server may provide hierarchical filename-based storage, or content-addressable storage. In many embodiments, the type of storage provided by the source and destination servers (i.e. filename-based or content-addressable) will be different.

Next, the embodiment creates a mapping database entry (330) that relates a first identifier such as a filename of the source data object to a second identifier such as a content-addressable storage key of the destination data object. The mapping database entry also includes information such as a description of a record retention policy that applies to the data object and (if necessary) information describing how the record retention policy at the source server differs from the record retention policy at the destination server. Mapping database entries may be stored in any sort of database. For example, a relational database management system (“RDBMS”), flat file, hierarchical or tree-structured system, or other database system/format may be used.

Chain-of-custody log records may also be created (340) to memorialize the record transfer event so that a forensic analysis could work backwards to determine where the record came from and how it arrived at the destination storage server. These log records may include the date and time of the record transfer, a hash or identifier of the contents of the record, the name of a person responsible for overseeing the transfer, or similar information.

The database entry (including any chain-of-custody log records) is stored in a mapping database (350) and an embodiment of the invention checks to see whether there are more data objects to be transferred from the source server (360). If there are, the iterative process continues. Otherwise, the records transfer is complete.

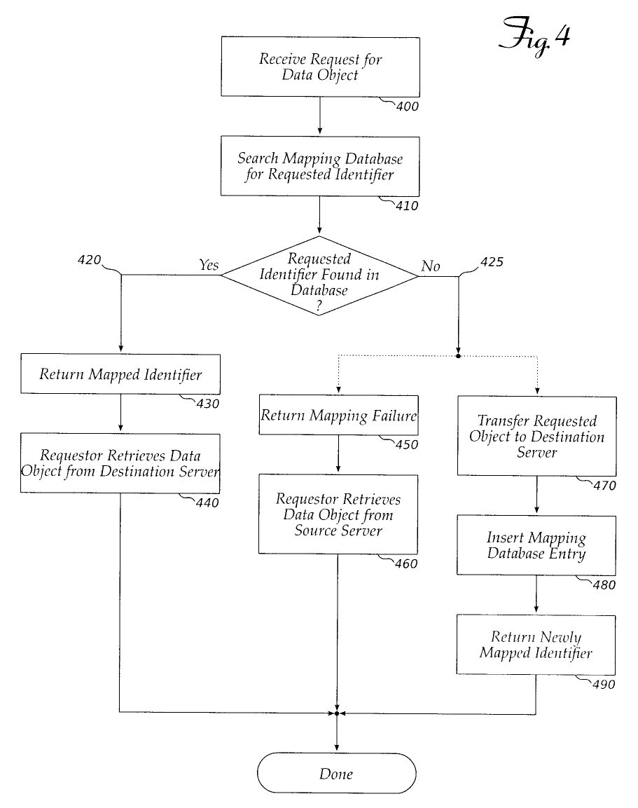

Embodiments of the invention can be used to transfer large quantities of information—commonly on the order of terabytes (10¹², or approximately 2⁴⁰, bytes). Such large record transfers may take days or weeks. To ensure continued data and application availability during this time, embodiments of the invention may include logic to implement the method outlined with reference to FIG. 4.

First, a request for a data object is received (400) from, e.g., an application server or other client entity. The request includes an identifier of the requested object. The identifier may be, for example, a key of a previously-stored data object on a content-addressable storage (“CAS”) server or a path of a previously-stored file on a filename addressable storage (“FAS”) server. The mapping database is searched for a record correlating the identifier of the requested data object (410).

As described above, the mapping database contains entries to correlate identifiers of data records that have been copied from the source server to the destination server. Therefore, the result of searching the mapping database indicates whether the requested data record can be found on the destination server, and if so, what its identifier is. Thus, if the requested identifier is found in the mapping database (420), the identifier of the copy of the data object at the destination server is returned to the requestor (430). The requestor can use this “mapped” identifier to retrieve the data it seeks from the destination server (440). If the requested identifier is not found in the mapping database (425), some embodiments return a “mapping failure” message (450) which the requester can treat as a direction to retrieve the requested data object from the source server (460) since it has not yet been transferred to the destination server. Other embodiments may copy the requested data object from the source server to the destination server immediately (470) (out of the order in which it would be transferred in the iteration described above), insert the appropriate mapping database entries (490), and return the freshly-mapped identifier (490).

New records created while the transfer is underway can be created directly on the destination server, without consulting the mapping database or communicating with the source server. When the application server accesses an earlier-created data object using the key or identifier suitable for the source server and obtains (through the mapping database) a corresponding identifier of the copy of the data object at the destination server, it may update its own records to reflect the new identifier. Alternatively, the mapping database may be maintained and operated as long as some system or entity needs to be able to access data objects by their identifiers at the source system. Even after all data objects have been transferred, the mapping database may be essential to ensure continued operation of the application server.

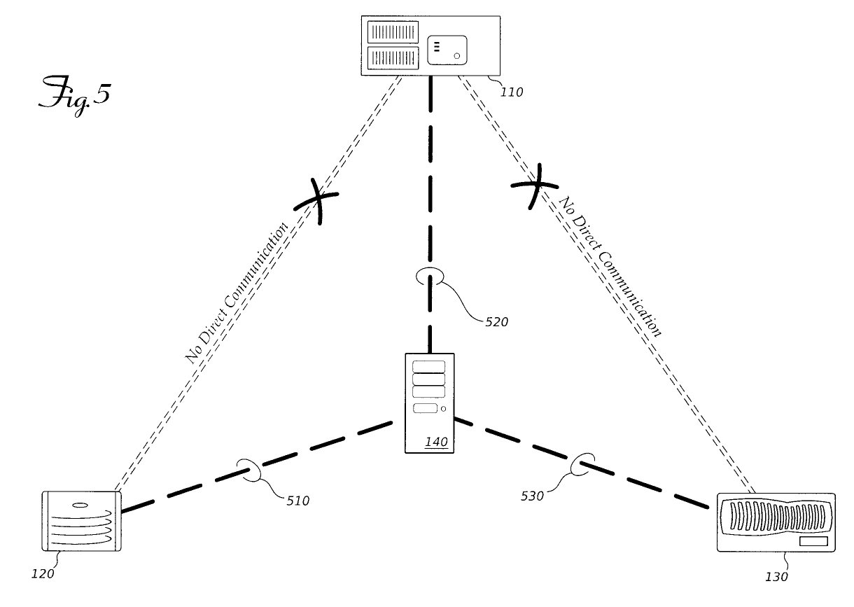

The foregoing operations can be contrasted with a different approach to migrating data records shown in FIG. 5. There, application server 110 communicates exclusively with director 140. Director 140 maintains a mapping table and transfers data from source server 120 to destination server 130 (or vice versa), but the actual location of data is transparent to application server 110: director 140 retrieves requested objects from the appropriate location and returns them to application server 110 as if the objects were located at director 140 itself. This operational approach has several drawbacks: first, it interposes an additional entity between application server 110 and the storage server that actually contains the data. This may reduce system performance. In the system described with reference to FIG. 4, the application server obtains the desired data object directly from the storage server that has it. Second, restrictions on protocol use may prevent director 140 from using the protocol of communication channel 510 over communication channel 520, or from “translating” between the protocol used over communication channel 530 and the protocol used over communication channel 520. The system described with reference to FIG. 4 avoids this problem by separating the client-server interactions into several distinct domains, each of which is operated in a way that respects applicable protocol use restrictions.

Although the data mapping and transfer operations have been described generically in the foregoing material (i.e. source and destination storage servers may be either filename-addressable or content-addressable servers, and may be of similar or dissimilar types) it is appreciated that embodiments of the invention may be particularly useful in the following situation. Consider the case of a user who has a large amount of legacy application data stored on a content-addressable storage (“CAS”) server. Some or all of the data is subject to record retention requirements. For example, the Health Insurance Portability and Accessibility Act (“HIPAA”) mandates specific retention periods (two years, five years, six years or longer, depending on the type of information contained in the records), so if the user's legacy application data contains healthcare information, some of the records must be carefully preserved. Similar retention requirements are imposed on corporate accounting information by the Sarbanes-Oxley Act.

The CAS server where the records are stored communicates with one or more application servers using a proprietary protocol. The user wishes to migrate the application's storage onto a filename-addressable storage (“FAS”) server, such as a server offering Network File System (“NFS”)-protocol access, without impacting the application's availability during the migration, without violating restrictions on the use of the CAS server's proprietary protocol, and without breaching the record retention requirements. Data mapping and transfer as described above may permit the user to move data from a proprietary-protocol-access system to a public-protocol-access system while achieving all of these goals.

An embodiment of the invention may be a machine-readable medium having stored thereon instructions which cause a programmable processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROM), Read-Only Memory (ROM), Random Access Memory (RAM), and Erasable Programmable Read-Only Memory (EPROM).

The applications of the present invention have been described largely by reference to specific examples and in terms of particular allocations of functionality to certain hardware and/or software components. However, those of skill in the art will recognize that data records, retention policy information and chain-of-custody information can be transferred between a content-addressable storage server and a file server by software and hardware that distribute the functions of embodiments of this invention differently than herein described. Such variations and implementations are understood to be captured according to the following claims.

We claim:

1. A method of transferring data comprising:
iterating through a set of data objects stored on a source server;
copying a source data object of the set to a destination data object at a destination server; and
storing a source identifier of the source data object at the source server, a destination identifier of the destination data object at the destination server, a retention policy of the destination data object, and a policy discrepancy indicator in a mapping database.

2. The method of claim 1, further comprising:
receiving a request for a requested data object, the request including a requested identifier of the requested data object;
searching for the requested identifier in the mapping database; and
returning a mapped identifier of a copy of the requested data object at the destination server if the requested identifier is found in the mapping database.

3. The method of claim 1, further comprising:
storing a chain-of-custody record to reflect the copying operation.

4. The method of claim 2 wherein the request is formatted according to a proprietary protocol.

5. The method of claim 2 wherein the request is formatted according to a public protocol.

6. The method of claim 5 wherein the public protocol is Network File System (“NFS”).

7. A system comprising:
a content-addressable storage (“CAS”) server;
a filename-addressable storage (“FAS”) server;
an application server to read and write data records associated with an identifier;
a mapping database to link a key of a data object on the CAS server, a name of a data object on the FAS server, and a data retention policy of the data object; and
steering logic to indicate whether data corresponding to the identifier is located on the CAS server or the FAS server.

8. The system of claim 7, further comprising:
data transfer logic to copy a data object from the CAS server to the FAS server and insert an entry into the mapping database.

9. The system of claim 7, further comprising:
data transfer logic to copy a data object from the FAS server to the CAS server and insert an entry into the mapping database.

10. The system of claim 7 wherein one of the CAS server and the FAS server responds to a proprietary data access protocol; and another of the CAS server and the FAS server responds to a public data access protocol.

11. The system of claim 10 wherein the public data access protocol is one of a Network File System (“NFS”) protocol and a Common Internet File System (“CIFS”) protocol.

12. The system of claim 7 wherein the data records are subject to record retention requirements under one of a Healthcare Insurance Portability and Accessibility Act (“HIPAA”) or a Sarbanes-Oxley Act.

13. A machine-readable medium containing instructions to cause a programmable processor to perform operations comprising:
receiving a request to access a file identified by a path;
searching for the path in a mapping database;
extracting a key from a database record located by the searching operation;
accessing a data object identified by the key at a content-addressable storage (“CAS”) server; and
replying to the request.

14. The machine-readable medium of claim 13, containing additional instructions to cause the programmable processor to perform operations comprising:
copying a file from a filename-addressable storage (“FAS”) server to a data object at the CAS server; and
creating a new database record to correlate a path of the file, a key of the data object, and a retention policy of the data object.

15. The machine-readable medium of claim 13 wherein the data object is subject to a legal retention requirement pursuant to a Healthcare Insurance Portability and Accessibility Act (“HIPAA”) or a Sarbanes-Oxley act.

16. A machine-readable medium containing instructions to cause a programmable processor to perform operations comprising:
receiving a request to access a data object identified by a key;
searching for the key in a mapping database;
extracting a path from a database record located by the searching operation;
accessing a file identified by the path at a filename-addressable storage (“FAS”) server; and
replying to the request.

17. The machine-readable medium of claim 16, containing additional instructions to cause the programmable processor to perform operations comprising:
copying a data object from a content-addressable storage (“CAS”) server to the file at the FAS server; and
creating a new database record to correlate a path of the file, the key of the data object, and a retention policy of the file.

18. The machine-readable medium of claim 17 wherein the retention policy of the file complies with one of a Healthcare Insurance Portability and Accessibility Act (“HIPAA”) requirement or a Sarbanes-Oxley Act requirement.

19. The machine-readable medium of claim 16 wherein the request conforms to a proprietary protocol.

20. The machine-readable medium of claim 16 wherein the mapping database is one of a Relational Database Management System (“RDBMS”) database, a flat file, or a hierarchical database.
